(19) United States
(12) Patent Application Publication
(10) Pub. No.: US 2005/0162035 A1
(43) Pub. Date: Jul. 28, 2005

(54) Brush and brush holder assembly for a micro horsepower motor

(75) Inventor: Athanase N. Tsergas, Wood Dale, IL (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Molon Motor and Coil Corporation, Rolling Meadows, IL (US)

(21) Appl. No.: 10/761,252

(22) Filed: Jan. 22, 2004

(51) Int. Cl. H02K 13/00; H01R 39/40

(52) U.S. Cl. 310/248; 310/249; 310/246; 310/239

(57) ABSTRACT

A brush and brush holder assembly for a micro horsepower electric motor includes a brush having a tip with a recessed portion; a brush holder surrounding the tip of the brush and having a cutout portion; a shunt carrying current to the tip of the brush; and an independent coil wire spring which does not carry current. This independent coil wire spring has an end which protrudes into the cutout portion of the brush holder and applies constant pressure to the recessed portion in the tip of the brush. The brush and brush holder assembly also has an electrical connection attached to the shunt. This electrical connection may carry direct current to the shunt.

### BACKGROUND OF THE INVENTION

1. Field of the Invention

The invention relates to a brush and a holder assembly therefor, particularly for a micro horsepower (hereinafter HP) electric motor.

2. Discussion of the Prior Art

A micro HP electric motor may be defined as one operating at 0.001 HP or less. Such a micro HP electric motor may have a maximum torque between 1.2 and 1.6 inch-ounces. Similarly, a fractional HP electric motor may be defined as an electric motor operating at less than one HP but more than 0.001 HP.

In the known prior art, a leaf spring usually acts as a brush holder. This leaf spring routinely gets hot because current is carried through the leaf spring to the brush itself. As a result of the heat generated by the electric current passing through the leaf spring, arcing often occurs and causes wear on the commutator. This wear consequently reduces the efficiency of the electric motor.

A preliminary patentability search uncovered several U.S. patents disclosing devices with structures similar to the present invention but for usage in large electric motors having much more than one horsepower. Thus, it would not be obvious to one of ordinary skill in the related art to modify these prior art devices for use in fractional and micro HP electric motors without ignoring their teachings which are directed to large-scale electric motors.

The most pertinent prior art references are believed to be the following: U.S. Pat. No. 4,163,167 which was issued to Zelt et al. on Jul. 31, 1979; U.S. Pat. No. 4,559,465 which was issued to Gagneux on Dec. 17, 1985; U.S. Pat. No. 4,593,220 which was issued to Cousins et al. on Jun. 3, 1986; U.S. Pat. No. 5,907,207 which was issued to Peot et al. on May 25, 1999; U.S. Pat. No. 6,169,351 which was issued to Bohart et al. on Jan. 2, 2001; and U.S. Pat. No. 6,563,245 which was issued to Suzuki et al. on May 13, 2003.

Other secondary prior art references are believed to be the following: U.S. Pat. No. 4,085,346 which was issued to Yoshida on Apr. 18, 1978; U.S. Pat. No. 4,088,912 which was issued to Yoshida on May 9, 1978; U.S. Pat. No. 4,238,703 which was issued to Yoshida on Dec. 9, 1980; and U.S. Pat. No. 4,749,899 which was issued to Ishizawa et al. on Jun. 7, 1988.

Five examples of prior art brush and brush holders are illustrated schematically in FIGS. 1, 2A, 2B, 3 and 4 of the drawings.

FIG. 1 shows an exploded schematic view of the commonest brush system which is used in most power tools, such as hand-held drills, and small electrical appliances. Electrical current is transferred to a tip 11 of a carbon brush 10 through an eyelet 12 which surrounds the tip 11 at one end and which is attached at another end to a lead wire 14. The eyelet 12 is supported in place on the tip 11 by a spring 16 which carries some current and therefore becomes hot during operation. A high-temperature plastic holder 18 supports the brush 10.

FIG. 2A shows a schematic view of a prior art brush system which is typically used in heavy-duty electrical devices, such as a large drill, a tabletop mixer, etc. These devices need more current than the lightweight tools and appliances using a brush system similar to FIG. 1. Thus, in the brush system of FIG. 2A, the arrangement of parts is different than the arrangement of FIG. 1. For example, there is no eyelet 12 with its lead wire 14. Instead, in the system of FIG. 2A, most of the amperage is delivered to a carbon brush 20 through a brass holder 28. A connection 24 attaches the holder 28 to a lead wire (not shown). Current travels from the lead wire to the connection 24, through the holder 28 to an end cap 22, through a copper pin tail 21 which is capable of carrying the high amperage required to operate heavy-duty electrical devices. The pin tail 21 leads the current into the brush 20. A spring 26 is wrapped spirally around the pin tail 21 but does not contact the pin tail 21. However, the spring 26 is connected at one end to the end cap 22 and is connected at an opposite end to the brush 20. Thus, the spring 26 is heated by the current which passes therethrough.

In many cases after a heavy electrical load is applied, particularly when operating in high-temperature ambient environments, the spring 16 of FIG. 1 and the spring 26 of FIG. 2A may become brittle so that their movement is retarded, contact pressure is reduced and frequent arcing occurs. Eventually, the springs 16 and 26 will fail by breaking. Without such failure being seen, the arcing becomes heavy, causes wear and reduces the efficiency of a related commutator (not shown). Ultimately, the commutator will be destroyed.

FIG. 2B shows a schematic view of a prior art brush and brush holder system used in many large alternating current (AC) or direct current (DC) motors that have a more heavy duty usage than the motors for which the system of FIG. 2A is used. The motor in which the brush system of FIG. 2B is used typically operates under heavy duty conditions at two to 20 HP.

In FIG. 2B, current enters from either an AC or a DC connection 224 and travels through a pin tail (not shown), wrapped tightly by a spring 226, to a tip 211 of a carbon brush 200. A leaf or coil spring 223 applies constant pressure to brush holders 228 which may be made of either brass or high-temperature resistant plastic.

Approximately 95% of micro motors, such as those used in cameras, recorders, small gear motors, etc., use the leaf or so-called blade-type prior art brush holder seen in FIG. 3. This holder has a very low manufacturing cost. However, it cannot carry a high current for a long period of time. Also, the brush length is very short, thus reducing the operational HP. Furthermore, the blade may some times lose tension and consequently the efficiency of the motor is reduced.

FIG. 3 shows a schematic view of a prior art brush system used in most micro motors. A beryllium-copper blade 38 carries a very low current to a tip or neck 31 which is wedged into a notch 39 at one end of the blade 38. Current travels from the blade 38 to the neck 31 into a carbon brush 30.

FIG. 4 shows a schematic view of relatively new prior art brush and brush holder system used in a few micro motors. Current enters a connection 44 and passes through a spring 46 which is supported in place by a metallic bump 47. The spring 46 carries the current directly to a carbon brush 40. A brass brush holder 48 surrounds a lower part of the spring 46 and supports the spring 46 in its position on the brush 40.

In order to improve the performance of micro motors, particularly those used in small electrical appliances, some manufacturers have recently developed a more complicated brush and brush holder system which is shown in FIG. 4. However, in this prior art brush system, most of the current is transferred through the spring 46. Thus, this so-called improvement includes all of the drawbacks of the earlier systems illustrated in FIGS. 1 and 2A.

Despite developments in the prior art, no simple brush and brush holder system for carrying current to a micro motor has been developed to reduce spring failure, to eliminate arcing and to prevent destruction of the commutator, thereby making the micro motor more stable and more efficient.

### SUMMARY OF THE INVENTION

A primary object of the invention is to provide a brush and a brush holder system for carrying minimal current to a micro motor or the like so that the spring does not fail, arcing is eliminated and the commutator is not destroyed.

A secondary object of the invention is to provide a brush and a brush holder system that makes a micro motor, operating at 0.001 HP or less, more stable and more efficient than micro motors using known prior art brush and brush holder systems.

In the invention, an independent coil wire spring provides a constant pressure on the brush and the current is carried to the brush by a wavy pin tail or a shunt so that there is no spring retardation caused by current flow therein.

### BRIEF DESCRIPTION OF THE DRAWINGS

A more complete appreciation of the invention and many of its advantages will be readily obtained as the invention becomes better understood by reference to the following detailed description when considered in connection with the accompanying drawings.

FIG. 1 shows an exploded schematic view of a first type of a prior art brush and brush holder system.

FIG. 2A shows a schematic view of a second type of a prior art brush and brush holder system.

FIG. 2B shows a schematic view of a third type of a prior art brush and brush holder system.

FIG. 3 shows a schematic view of a fourth type of a prior art brush and brush holder system.

FIG. 4 shows a schematic view of a fifth type of a prior art brush and brush holder system.

FIG. 5 shows a schematic view of a preferred embodiment of the present inventive brush and brush holder system.

### DETAILED DESCRIPTION OF THE PREFERRED EMBODIMENT

Referring now to the drawings, wherein like reference numerals designate identical or corresponding parts throughout the schematic view, attention is directed to FIG. 5 which shows the preferred embodiment of the invention.

The features of the invention will become apparent in the course of the following description of the exemplary embodiment which is given for illustration of the invention and is not intended to limit the invention to the specific embodiment shown in FIG. 5.

In FIG. 5, a connection 54 carries electric current to a wavy pin tail or shunt 56 that contacts a tip 51 of a carbon brush 50. The electric current may be either AC or DC. However, DC is preferred. The brush 50 is surrounded partly at one end where the tip 51 is located by a brass brush holder 58 which has a longitudinal cutout portion 55. The brush holder 58 is attached to a part of a plastic end bell 60.

An independent coil wire spring 53 is wrapped tightly around a projection 72 on a plastic post 70. One end 53E of the spring 53 is free while another end 53A of the spring 53 protrudes into the cutout portion 55 of the brush holder 58 and applies constant pressure to a recessed portion 50R in the tip 51 of the brush 50. An advantage of the recessed portion 50R in the tip 51 is that it keeps the end 53A of the spring 53 always in contact with the brush 50 so that the end 53A will not jump away from the tip 51 if the brush 50 and the spring 53 are jarred. The spring 53 is considered independent because it does not carry electric current.

Interestingly, this approach will not work in fractional HP motors operating above 0.001 but less than 1.0 HP because the wavy pin tail or shunt 56 must be made thicker to carry the higher current. Consequently, it has been found that, when the current is higher and the shunt 56 is thick enough to carry such a current so that a fractional HP motor can be operated between 0.001 and 1.0 HP, the shunt 56 quickly loses its resilience and breaks.

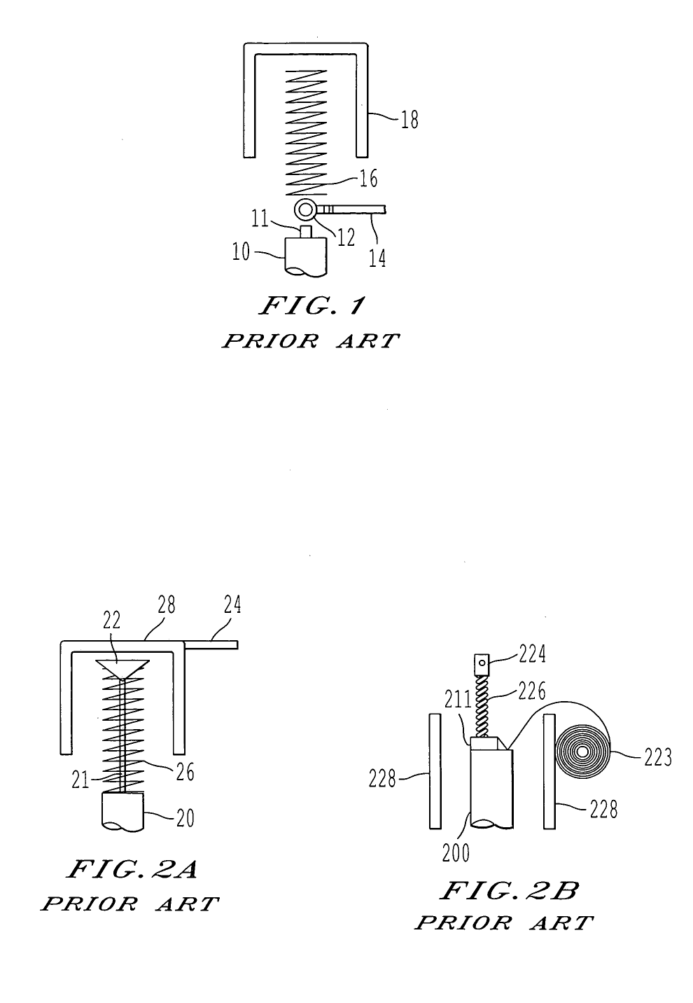

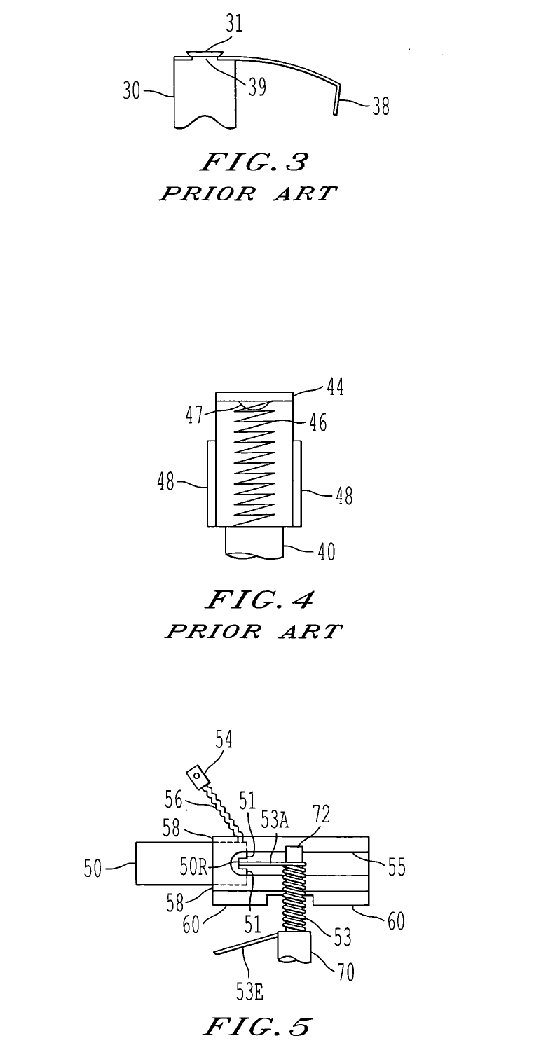

Accordingly, since this approach will not work in fractional HP motors, a person of ordinary skill in this technology would assume that this approach would also not work in micro motors, thus teaching away from the present invention. Nevertheless, contrary to expectations, the inventor combined some elements used in the prior art brush systems operating in heavy duty motors up to 20 HP, as shown in FIG. 2B, modified these elements, and added new elements to develop a brush and a brush holder assembly which is new, useful, unobvious and operable for a micro motor. In other words, the inventor has found that the thin shunt 56 can easily carry an electric current small enough to run a micro motor operating at less than 0.001 HP without any immediate deleterious effect.

Clearly, numerous modifications and variations of the invention are possible in light of the above teachings. Therefore, it should be understood that, within the scope of the appended claims, the invention may be practiced in other ways than as specifically described hereinabove.

1. A brush and brush holder assembly for a micro horsepower (HP) electric motor, comprising:
a. a brush having a tip;
b. a brush holder surrounding the tip of the brush;
c. a shunt carrying current to the tip of the brush; and
d. an independent coil wire spring applying constant pressure to the brush; wherein the electric motor is operable at less than 0.001 HP.

2. A brush and brush holder assembly according to claim 1, further comprising:
a. an electrical connection attached to the shunt.

3. A brush and brush holder assembly according to claim 2, wherein:
said electrical connection carries direct current to the shunt.

4. A brush and brush holder assembly according to claim 1, wherein:
said tip of the brush has a recessed portion.

5. A brush and brush holder assembly, according to claim 1 wherein:
said brush holder has a cutout portion.

6. A brush and brush holder assembly, according to claim 5, wherein:
said independent coil wire spring has an end which protrudes into the cutout portion of the brush holder and applies constant pressure to the recessed portion in the tip of the brush.
